(19) United States
(12) Patent Application Publication
(10) Pub. No.: US 2019/0054576 A1
(43) Pub. Date: Feb. 21, 2019

(54) BRAZING MATERIAL COMPOSITION AND MANUFACTURING METHOD THEREOF

(71) Applicant: Institute of Nuclear Energy Research, Atomic Energy Council, Executive Yuan, R.O.C, Taoyuan (TW)

(72) Inventors: Liang-Wei Huang, Taoyuan (TW); Chien-Kuo Liu, Taoyuan (TW); Yung-Neng Cheng, Taoyuan (TW); Ruey-Yi Lee, Taoyuan (TW)

(21) Appl. No.: 15/884,821

(22) Filed: Jan. 31, 2018

(30) Foreign Application Priority Data
Aug. 15, 2017 (TW) 106127660

(51) Int. Cl. B23K 35/30; C22C 5/06; C22C 1/04; C22C 30/00

(52) U.S. Cl. CPC B23K 35/3006; C22C 30/00; C22C 1/0466; C22C 5/06

(57) ABSTRACT

A brazing material composition is provided, which may include Ge, Ag and Si, where the atomic percentage of Ge may be between 0<Ge≤20 at %, the atomic percentage of Ag may be between 20≤Ag<88 at %, and the atomic percentage of Si may be between 12<Si≤60 at %. The thermo-physical properties of the brazing material composition can be easily adjusted; besides, the brazing material composition not only has low thermal expansion coefficient, but also has great structure stability and gas-tightness at elevated temperatures.

### CROSS-REFERENCE TO RELATED APPLICATION

This application claims the benefit of Taiwan Patent Application No. 106127660, filed on Aug. 15, 2017, in the Taiwan Intellectual Property Office, the disclosure of which is incorporated herein in its entirety by reference.

### BACKGROUND OF THE INVENTION

### 1. Field of the Invention

The present invention generally relates to an alloy material, in particular to a brazing material composition. The present invention further related to a method for manufacturing the brazing material composition.

### 2. Description of the Related Art

With the advance of technology, the structure of mechanical workpieces tends to be complicated; thus, if mechanical workpieces are manufactured by the conventional casting method or integrally formed, the difficulty of the manufacturing process will be significantly increased and the cost will also go up. Accordingly, it can reduce the difficulty of the manufacturing process and decrease the cost to join several small workpieces together to form a large workpiece.

Brazing is a widely used technology, which uses a brazing material composition as the metal filler; as the melting point of the metal filler is lower than that of the workpieces, so the metal filler can be melted by heating, and the melted metal filler can be filled between two workpieces via capillarity; then, the workpieces can be joined together after the melted metal filler is solidified. Brazing can join two metal workpieces made of the same material or made of different materials together; besides, brazing can also join a metal workpiece and a non-metal workpiece (e.g. ceramic) together.

As mechanical workpieces may be used at an elevated temperature environment, a highly corrosive environment or other harsh environments, the material of the metal filler is mainly composed of an noble metal, such as Au, Ag, Pd and Pt, etc.; among these metals, Ag is the most frequently-used material of the metal filler; however, the Ag alloy usually has a high thermal expansion coefficient (18.2˜19.6 ppm/° C.), which cannot match that of most materials; accordingly, the application of the Ag alloy is strictly restricted.

Currently, for the purpose of solving the problem that the thermal expansion coefficient of the metal filler is overhigh, most metal fillers include additional additives, such as ceramic particles and metals, etc., with low thermal expansion coefficients or carbon fiber in order to control the thermal expansion coefficients of the metal fillers, as disclosed by U.S. Pat. No. 6,742,700 and US patent publication No.: 20080131723; however, these metal fillers should be manufactured by several processes, so the manufacturing process of these metal fillers is very complicated.

Da-Tian Cui (The Chinese Journal of Nonferrous Metals, 17(9), pp. 1501-1505, 2007) discloses a middle-temperature Au—Ag—Ge—Si metal filler, which is fragile and has a low melting point range (451˜506° C.); for the reason, the application of the metal filler is strictly restricted.

Therefore, it has become an important issue to provide a brazing material composition to effectively improve the shortcomings of the conventional brazing material compositions.

### SUMMARY OF THE INVENTION

Therefore, it is a primary objective of the present invention to provide a brazing material composition and the method for manufacturing the same to improve the shortcomings of the conventional brazing material compositions.

To achieve the foregoing objective, the present invention provides a brazing material composition, which may include Ge, Ag and Si, where the atomic percentage of Ge may be between 0<Ge≤20 at %, the atomic percentage of Ag may be between 20≤Ag<88 at %, and the atomic percentage of Si may be between 12<Si≤60 at %. The thermo-physical properties of the brazing material composition can be easily adjusted; besides, the brazing material composition not only has a low thermal expansion coefficient, but also has great structure stability and gas-tightness at elevated temperatures.

In a preferred embodiment of the present invention, the thermal expansion coefficient of the brazing material composition may be between 7.4˜18.5 ppm/° C.

In a preferred embodiment of the present invention, the brazing material composition may be manufactured by the smelting process.

In a preferred embodiment of the present invention, the melting point of the brazing material composition may be between 600˜1200° C.

In a preferred embodiment of the present invention, the average leakage rate of the brazing material composition may be around 10⁻⁴ mbar·l/s/cm.

To achieve the foregoing objective, the present invention further provides a method for manufacturing a brazing material composition, which may include the following steps: mixing the Ge powder, the Ag powder and the Si powder to generate the mixed powder, wherein the atomic percentage of Ge of the mixed powder is between 0<Ge≤20 at %, the atomic percentage of Ag of the mixed powder is between 20≤Ag<88 at %, and the atomic percentage of Si of the mixed powder is between 12<Si≤60 at %; processing the mixed powder by the sintering process to generate a first material; putting the first material into a smelting furnace, pumping the air out of a chamber of the smelting furnace to make the chamber be in vacuum status, and injecting the protective gas into the chamber; processing the first material by the smelting process to generate a second material; and processing the second material in the protective gas environments by the annealing process in order to homogenize Ge, Si and Ag of the second material to generate the brazing material composition.

In a preferred embodiment of the present invention, the method for manufacturing the brazing material composition of claim 6 may further include the following step: screening the Ge powder, the Ag powder and the Si powder to make an average particle diameter of the Ge powder, the Ag powder and the Si powder is lower than 45 μm.

In a preferred embodiment of the present invention, the step of putting the first material into the smelting furnace, pumping the air out of the chamber of the smelting furnace to make the chamber be in the vacuum status, and injecting the protective gas into the chamber may be executed for at least two times.

In a preferred embodiment of the present invention, the temperature of the annealing process may be 0.7˜0.8 times the melting point of the second material.

In a preferred embodiment of the present invention, the step of processing the first material by the smelting process to generate the second material may further include the following step: turning over the second material and re-executing the smelting process.

In a preferred embodiment of the present invention, the melting point of the brazing material composition may be between 600˜1200° C.

In a preferred embodiment of the present invention, the average leakage rate of the brazing material composition may be around 10⁴ mbar·l/s/cm.

The brazing material composition and the method for manufacturing the same according to the present invention may have the following advantages:

(1) In one embodiment of the present invention, the brazing material composition is an Ag—Ge—Si ternary alloy with special composition ratio and without ceramic particles or other additives, so can be manufactured by just by the smelting process; thus, the manufacturing process of the brazing material composition can be significantly simplified.

(2) In one embodiment of the present invention, the brazing material composition is an Ag—Ge—Si ternary alloy with special composition ratio, and the thermophysical properties thereof can be adjusted by changing the composition ratio; thus, the brazing material composition can be used to join workpieces of different thermal expansion coefficients together, which is very suitable for the development of multi-layer composite materials.

(3) In one embodiment of the present invention, the thermal expansion coefficient (7.4˜18.5 ppm/° C.) and the melting point range (600˜1200° C.) of the brazing material composition are adjustable, so the brazing material composition can be applied to various workpieces; therefore, the application of the brazing material composition is more comprehensive.

(4) In one embodiment of the present invention, the brazing material composition is of high temperature durability; after being processed by the high-temperature heat treatment for a long time (750° C. for 1000 hours), the structure of the brazing material composition still remains intact without being damaged by high temperature; thus, the brazing material composition is very suitable for serving as the sealing material at elevated temperature environments.

(5) In one embodiment of the present invention, the brazing material composition is of great gas-tightness; after being processed by the high-temperature heat treatment for a long time (750° C. for 1000 hours), the structure of the brazing material composition still has great gas-tightness (about 10⁴ mbar·l/s/cm); thus, the brazing material composition is very suitable for serving as the sealing material at elevated temperature environments.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a ternary phase diagram of a brazing material composition of the first embodiment in accordance with the present invention and the composition ratio range thereof.

FIG. 2 is a flow chart of a method for manufacturing the brazing material composition of the first embodiment in accordance with the present invention.

FIG. 3 is a micro-structural image of the brazing material composition of the first embodiment in accordance with the present invention.

FIG. 4 is an analysis curve diagram of the thermophysical properties of the brazing material composition of the first embodiment in accordance with the present invention.

FIG. 5 is a micro-structural image of the joint interface of the brazing material composition of the first embodiment in accordance with the present invention.

FIG. 6 is a schematic view of the brazing test specimen of the brazing material composition of the first embodiment in accordance with the present invention.

FIG. 7A is an interface micro-structural image of the brazing test specimen of the brazing material composition before the heat treatment of the first embodiment in accordance with the present invention.

FIG. 7B is an interface micro-structural image of the brazing test specimen of the brazing material composition after the heat treatment of the first embodiment in accordance with the present invention.

FIG. 8 is an average leakage rate curve diagram of the brazing test specimen during the high-temperature heat treatment of the brazing material composition of the first embodiment in accordance with the present invention.

### DETAILED DESCRIPTION OF THE PREFERRED EMBODIMENTS

The technical content of the present invention will become apparent by the detailed description of the following embodiments and the illustration of related drawings as follows.

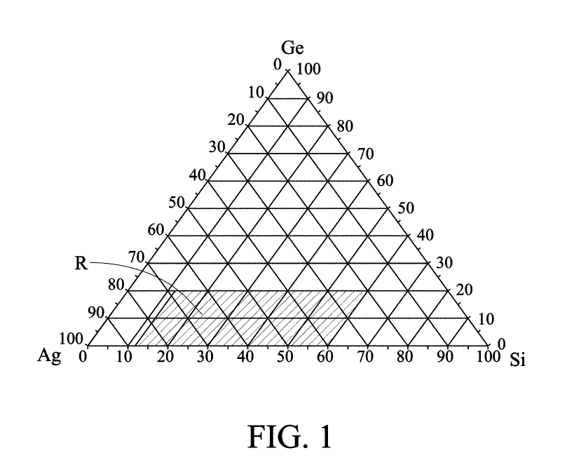

Please refer to FIG. 1, which is a ternary phase diagram of a brazing material composition of the first embodiment in accordance with the present invention and the composition ratio range thereof; as shown in FIG. 1, the brazing material composition of the embodiment may be an Ag—Ge—Si ternary alloy with special composition ratio without ceramic particles or other additives, and can be manufactured by the smelting process.

According to the composition ratio range R shown in FIG. 1, the brazing material composition of the embodiment may include Ge, Ag and Si; the atomic percentage of Ge may be between 0<Ge≤20 at %, the atomic percentage of Ag may be between 20≤Ag<88 at %, and the atomic percentage of Si o may be between 12<Si≤60 at %.

The thermophysical properties of the brazing material composition can be adjusted by changing the composition ratio thereof, so the brazing material composition can be used to join workpieces of different thermal expansion coefficients together; therefore, the brazing material composition is very suitable for the development of multi-layer composite materials; in addition, the thermal expansion coefficient and the melting point range of the brazing material composition may be between 7.4˜18.5 ppm/° C. and 600˜1200° C. respectively, which are adjustable, so the brazing material composition can be applied to various workpieces; thus, the application of the brazing material composition is more comprehensive.

In addition, the above special composition ratio enables the brazing material composition to have high temperature durability, and can be of great gas-tightness (about 10⁻⁴ mbar·l/s/cm) at elevated temperatures; after being processed by the high-temperature heat treatment for a long time (750° C. for 1000 hours), the structure of the brazing material composition still has great gas-tightness (about 10⁴ mbar·l/s/cm); thus, the brazing material composition is very suitable for serving as the sealing material at elevated temperature environments.

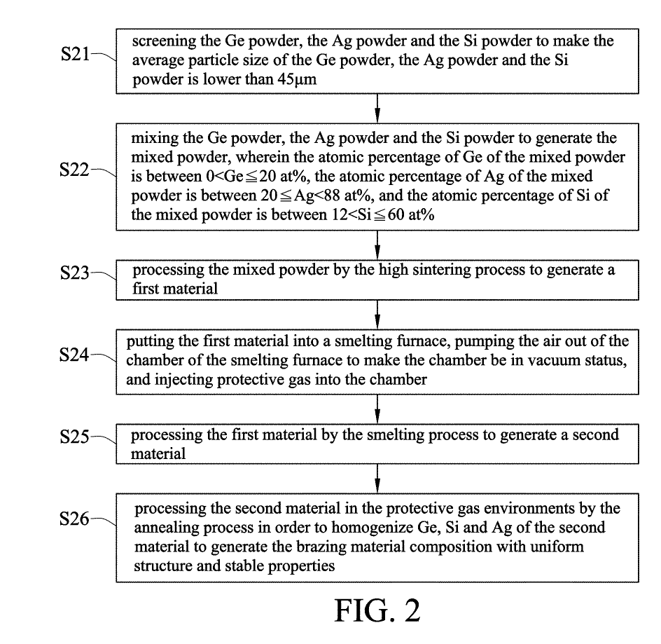

Please refer to FIG. 2, which is a flow chart of a method for manufacturing the brazing material composition of the first embodiment in accordance with the present invention; as shown in FIG. 2, the method for manufacturing the brazing material composition of the embodiment may include the following steps:

S21: screening the Ge powder, the Ag powder and the Si powder to make the average particle size of the Ge powder, the Ag powder and the Si powder is lower than 45 μm.

S22: mixing the Ge powder, the Ag powder and the Si powder to generate the mixed powder, wherein the atomic percentage of Ge of the mixed powder is between 0<Ge≤20 at %, the atomic percentage of Ag of the mixed powder is between 20≤Ag<88 at %, and the atomic percentage of Si of the mixed powder is between 12<Si≤60 at %.

S23: processing the mixed powder by the high sintering process to generate a first material;

S24: putting the first material into a smelting furnace, pumping the air out of the chamber of the smelting furnace to make the chamber be in vacuum status, and injecting protective gas into the chamber.

S25: processing the first material by the smelting process to generate a second material.

S26: processing the second material in the protective gas environments by the annealing process in order to homogenize Ge, Si and Ag of the second material to generate the brazing material composition with uniform structure and stable properties.

As described above, as the brazing material composition of the embodiment may be an Ag—Ge—Si ternary alloy with special composition ratio without ceramic particles or other additives, so it can be manufactured just by the smelting process, which can significantly simplify the manufacturing process and further reduce the cost.

It is worthy pointing out that the conventional brazing material compositions include additional additives metals with low thermal expansion coefficients, so should be manufactured by several processes, so the manufacturing processes of the conventional brazing material compositions are very complicated. On the contrary, according to one embodiment of the present invention, the brazing material composition is an Ag—Ge—Si ternary alloy with special composition ratio and without ceramic particles or other additives, so can be manufactured just by the smelting process; thus, the manufacturing process of the brazing material composition can be significantly simplified.

Also, the conventional brazing material compositions usually have high thermal expansion coefficients, which cannot match that of most materials; accordingly, the application of the conventional brazing material compositions alloy is strictly restricted, and cannot be applied to the development of the multi-layer composite materials. On the contrary, according to one embodiment of the present invention, the brazing material composition is an Ag—Ge—Si ternary alloy with special composition ratio, and the thermophysical properties thereof can be adjusted by changing the composition ratio; thus, the brazing material composition can be used to join workpieces of different thermal expansion coefficients together, which is very suitable for the development of multi-layer composite materials; in addition, the thermal expansion coefficient and the melting point range of the brazing material composition may be between 7.4˜18.5 ppm/° C. and 600˜1200° C. respectively, which are adjustable, so the brazing material composition can be applied to various workpieces; therefore, the application of the brazing material composition is more comprehensive.

Moreover, according to one embodiment of the present invention, the brazing material composition is of high temperature durability; after being processed by the high-temperature heat treatment for a long time (750° C. for 1000 hours), the structure of the brazing material composition still remains intact without being damaged by high temperature; thus, the brazing material composition is very suitable for serving as the sealing material at elevated temperature environments.

Furthermore, according to one embodiment of the present invention, the brazing material composition is of great gas-tightness; after being processed by the high-temperature heat treatment for a long time (750° C. for 1000 hours), the structure of the brazing material composition still has great gas-tightness (about 10⁻⁴ mbar·l/s/cm); thus, the brazing material composition is very suitable for serving as the sealing material at elevated temperature environments. Therefore, the present invention definitely has an inventive step.

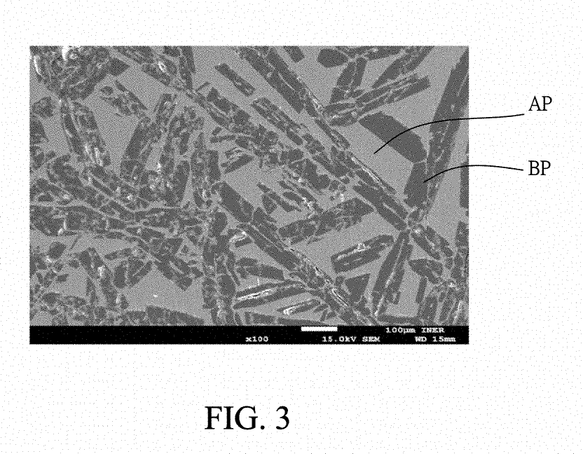

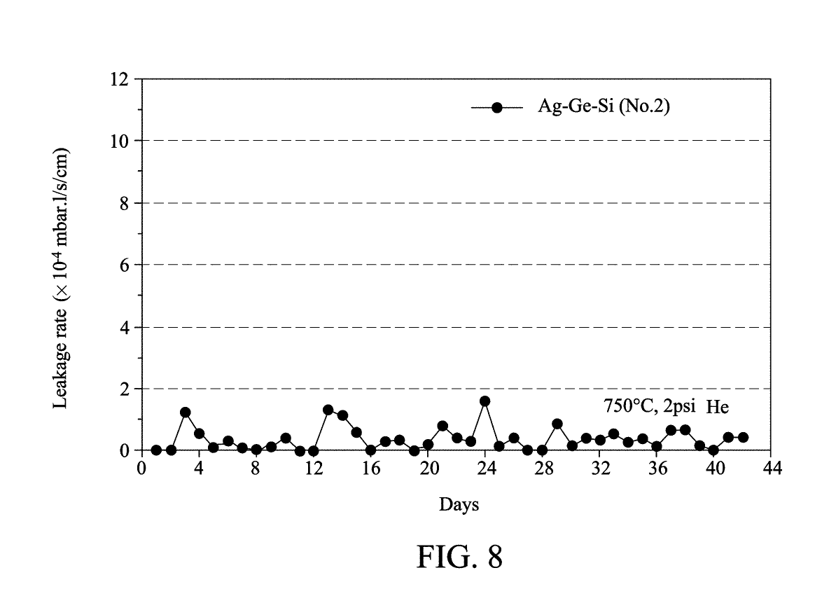

Please refer to FIG. 3˜FIG. 8, which are a micro-structural image, an analysis curve diagram of the thermophysical properties, a micro-structural image of the joint interface, a schematic view of the brazing test specimen, an interface micro-structural image of the brazing test specimen before the heat treatment, an interface micro-structural image of the brazing test specimen after the heat treatment and an average leakage rate curve diagram of the brazing test specimen during the high-temperature heat treatment of the brazing material composition of the first embodiment in accordance with the present invention respectively; according to the above composition ratio range of the brazing material composition, the embodiment takes several brazing material compositions with different composition ratios as the examples to illustrate the technical effects provided by the above composition ratio range.

The embodiment takes several brazing material compositions with different composition ratios as the examples, as shown in Table 1.

TABLE 1
Brazing material compositions with different composition ratios

| | Atomic percentage | Atomic percentage | Atomic percentage |
|---|---|---|---|
| Number | of Ag (at %) | of Ge (at %) | of Si (at %) |
| No. 1 | 84 | 3 | 13 |
| No. 2 | 77 | 3 | 20 |
| No. 3 | 67 | 3 | 30 |
| No. 4 | 47 | 3 | 50 |
| No. 5 | 37 | 3 | 60 |
| No. 6 | 77 | 10 | 13 |
| No. 7 | 30 | 10 | 60 |
| No. 8 | 67 | 20 | 13 |
| No. 9 | 50 | 20 | 30 |
| No. 10 | 20 | 20 | 60 |

FIG. 3 is the micro-structural image of the brazing material composition of the first embodiment in accordance with the present invention; as shown in FIG. 3, the micro-structural image of the brazing material composition may include two major phases, including the Ag—Ge phase AP (white base phase) and the Si—Ge phase BP (dark gray precipitated phase).

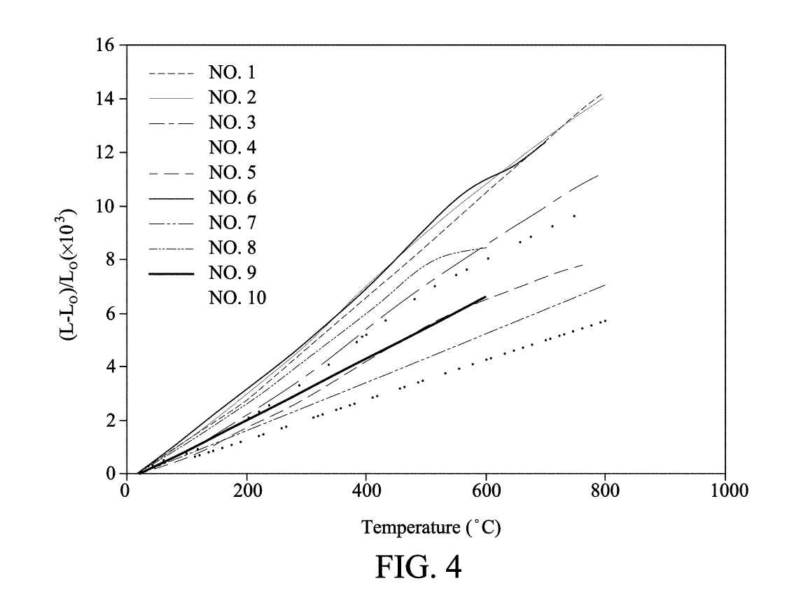

FIG. 4 is the analysis curve diagram of the thermophysical properties of the brazing material composition of the first embodiment in accordance with the present invention; as shown in FIG. 4, the thermophysical properties of the above brazing material compositions with different composition ratios are measured within a temperature interval, from the room temperature to the temperatures lower than the melting points of the brazing material compositions, and the slopes of the curves are converted to the average thermal expansion coefficients by Equation (1), as follows:

$$α = \frac{( L - Lo )}{Δ T} \qquad ( 1 )$$

In Equation (1), α is the thermal expansion coefficient; L_{O} is the original length of the brazing material composition; L−L_{O} is the elongation of the brazing material composition; ΔT is the measurement temperature interval.

The thermophysical properties of the above brazing material compositions with different composition ratios are as shown in Table 2.

TABLE 2
Thermophysical properties of brazing material compositions with different
composition ratios

| | Average thermal expansion coefficient | |
|---|---|---|
| Number | (ppm/° C.) | Melting point (° C.) |
| No. 1 | 18.5 (RT-800° C.) | 830 |
| No. 2 | 18.2 (RT-800° C.) | 830 |
| No. 3 | 14.6 (RT-800° C.) | 834 |
| No. 4 | 13.1 (RT-800° C.) | 1096 |
| No. 5 | 10.5 (RT-800° C.) | 1165 |
| No. 6 | 18.2 (RT-700° C.) | 788 |
| No. 7 | 9.1 (RT-800° C.) | 1034 |
| No. 8 | 14.5 (RT-600° C.) | 666 |
| No. 9 | 11.5 (RT-600° C.) | 672 |
| No. 10 | 7.4 (RT-800° C.) | 997 |

As shown in Table 2, the average thermal expansion coefficients of the above brazing material compositions with different composition ratios are between 7.4˜18.5 ppm/° C., and the smelting points thereof are between 600˜1200° C. As described above, the embodiment can mix Ag, Ge and Si by a special composition ratio range; which can enable the Ag—Ge—Si ternary alloy to have adjustable thermophysical properties to join workpieces with different thermal expansion coefficients together; thus, the brazing material composition is very suitable for the development of multi-layer composite materials or high-temperature sealing materials, such as boiler, heat exchanger, nuclear furnace, engine part, electronic packaging component, heat dissipation substrate for electronic component, mold and cutting tool, etc.

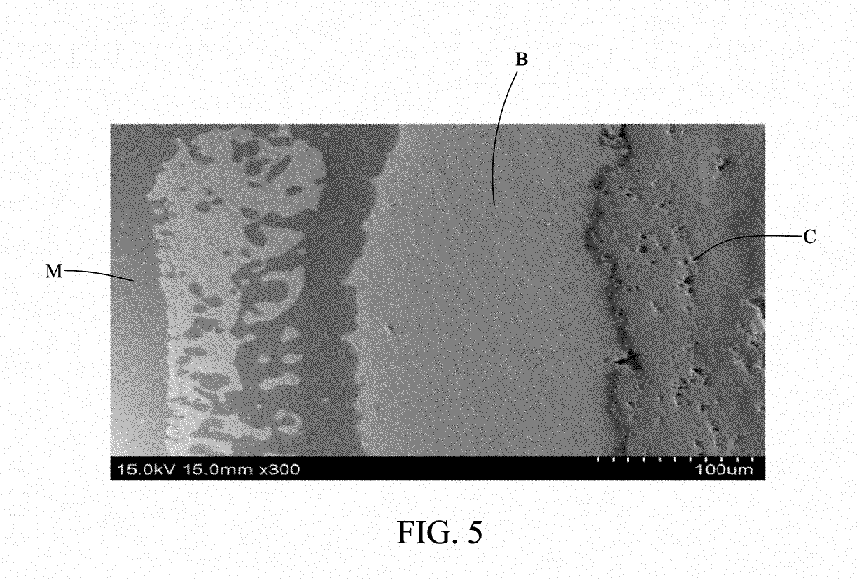

FIG. 5 is the micro-structural image of the joint interface of the brazing material composition of the first embodiment in accordance with the present invention; FIG. 5 takes the No. 5 brazing material composition B as an example to join a metal-based material M and a ceramic-based material C together to form a composite material, where the metal-based material M is a stainless steel (Crofer22H®, VDM GmbH), and the ceramic-based material C is a perovskite material (La_{0.8}Sr_{0.2}Ga_{0.8}Mg_{0.2}O₃). The thermal expansion coefficient of the stainless steel is about 13 ppm/° C., and the thermal expansion coefficient of the perovskite material is about 11 ppm/° C. As shown in FIG. 5, the micro-structural image of the joint interface shows the micro-structure of the joint interface between the brazing material composition B and the two base materials, M and C, does not obviously crack or peel off because the thermal expansion coefficient of the brazing material composition B matches the thermal expansion coefficients of the stainless steel and the perovskite material; thus, the brazing material can actually form a well joint.

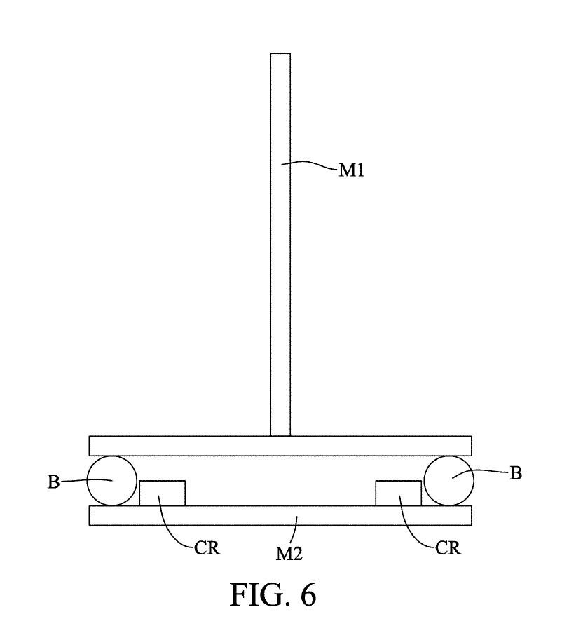

FIG. 6 is the schematic view of the brazing test specimen of the brazing material composition of the first embodiment in accordance with the present invention; as described above, the brazing material composition B can serve as a high-temperature sealing material; FIG. 6 takes the NO. 2 brazing material composition B as an example to a stainless-steel based material M1 and a stainless-steel based material M2 together; in addition, a ceramic pad CR is disposed between the stainless-steel based material M1 and the stainless steel based material M2; the average leakage rate at elevated temperatures is ˜10⁻⁴ mbar·l/s/cm.

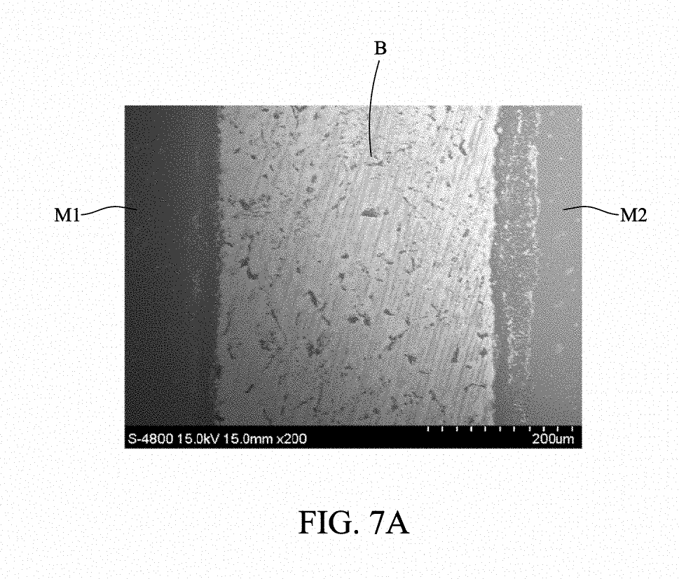

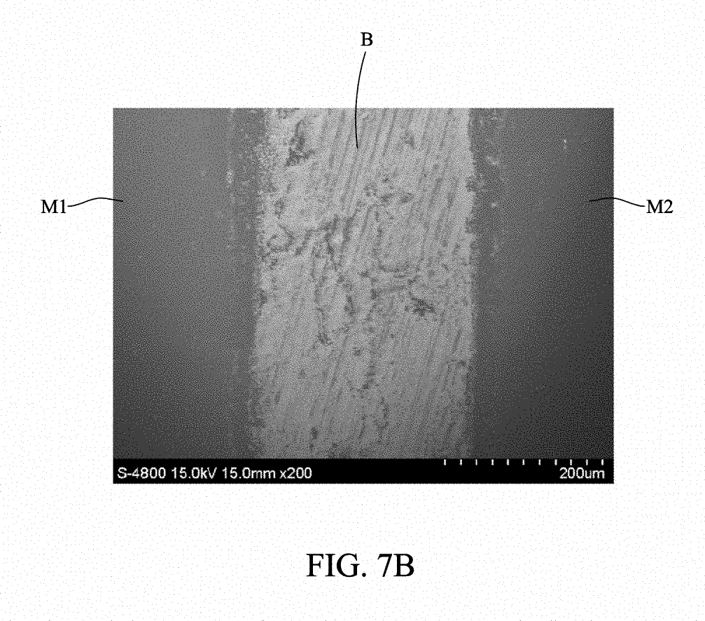

FIG. 7A and FIG. 7B are the interface micro-structural images of the brazing test specimen of the brazing material composition before and after the heat treatment respectively of the first embodiment in accordance with the present invention; as shown in FIG. 7A and FIG. 7B, the interfacial micro-structure between the brazing material composition B and the stainless-steel based materials, M1 and M2, can remain intact before and after the heat treatment.

FIG. 8 is the average leakage rate curve diagram of the brazing test specimen of the brazing material composition of the first embodiment in accordance with the present invention; as shown in FIG. 8, the average leakage rate of the brazing material composition B can remain 10⁴ mbar·l/s/cm during the high-temperature heat treatment, so the brazing material composition B can still be of great gas-tightness; thus, the brazing material composition B is very suitable for serving as the sealing material at elevated temperature environments.

To sum up, according to one embodiment of the present invention, the brazing material composition is an Ag—Ge—Si ternary alloy with special composition ratio and without ceramic particles or other additives, so can be manufactured just by the smelting process; thus, the manufacturing process of the brazing material composition can be significantly simplified.

Also, according to one embodiment of the present invention, the brazing material composition is an Ag—Ge—Si ternary alloy with special composition ratio, and the thermophysical properties thereof can be adjusted by changing the composition ratio; thus, the brazing material composition can be used to join workpieces of different thermal expansion coefficients together, which is very suitable for the development of multi-layer composite materials.

Besides, according to one embodiment of the present invention, the thermal expansion coefficient (7.4˜18.5 ppm/° C.) and the melting point range (600˜1200° C.) of the brazing material composition are adjustable, so the brazing material composition can be applied to various workpieces; therefore, the application of the brazing material composition is more comprehensive.

Moreover, according to one embodiment of the present invention, the brazing material composition is of high temperature durability; after being processed by the high-temperature heat treatment for a long time (750° C. for 1000 hours), the structure of the brazing material composition still remains intact without being damaged by high temperature; thus, the brazing material composition is very suitable for serving as the sealing material at elevated temperature environments.

Furthermore, according to one embodiment of the present invention, the brazing material composition is of great gas-tightness; after being processed by the high-temperature heat treatment for a long time (750° C. for 1000 hours), the structure of the brazing material composition still has great gas-tightness (about 10⁻⁴ mbar·l/s/cm); thus, the brazing material composition is very suitable for serving as the sealing material at elevated temperature environments.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A brazing material composition, comprising: Ge, Ag and Si, wherein an atomic percentage of Ge is between 0<Ge≤20 at %, an atomic percentage of Ag is between 20≤Ag<88 at %, and an atomic percentage of Si is between 12<Si≤60 at %.

2. The brazing material composition of claim 1, wherein a thermal expansion coefficient of the brazing material composition is between 7.4˜18.5 ppm/° C.

3. The brazing material composition of claim 1, wherein the brazing material composition is manufactured by a smelting process.

4. The brazing material composition of claim 2, wherein a melting point of the brazing material composition is between 600˜1200° C.

5. The brazing material composition of claim 4, wherein an average leakage rate of the brazing material composition is about 10⁻⁴ mbar·l/s/cm.

6. A method for manufacturing a brazing material composition, comprising the following steps:
mixing Ge, Ag and Si powders to generate mixed powders, wherein an atomic percentage of Ge in the mixed powders is between 0<Ge≤20 at %, an atomic percentage of Ag in the mixed powders is between 20≤Ag<88 at %, and an atomic percentage of Si in the mixed powders is between 12<Si≤60 at %;
processing the mixed powders by a sintering process at elevated temperatures to generate a first material;
putting the first material into a smelting furnace, pumping an air out of a chamber of the smelting furnace to make the chamber be in a vacuum status, and injecting a protective gas into the chamber;
processing the first material by a smelting process to generate a second material; and
processing the second material in a protective gas environment by an annealing process in order to homogenize Ge, Si and Ag of the second material to generate the brazing material composition.

7. The method for manufacturing the brazing material composition of claim 6, wherein a thermal expansion coefficient of the brazing material composition is between 7.4˜18.5 ppm/° C.

8. The method for manufacturing the brazing material composition of claim 6, further comprising a following step:
screening the Ge, Ag and Si powders to make an average particle size is lower than 45 μm.

9. The method for manufacturing the brazing material composition of claim 6, wherein the step of putting the first material into the smelting furnace, pumping the air out of the chamber of the smelting furnace to make the chamber be in the vacuum status, and injecting a protective gas into the chamber is executed for at least two times.

10. The method for manufacturing the brazing material composition of claim 6, wherein a temperature of the annealing process is 0.7˜0.8 times a melting point of the second material.

11. The method for manufacturing the brazing material composition of claim 6, wherein the step of processing the first material by the smelting process to generate the second material further comprising a following step:
turning over the second material and re-executing the smelting process.

12. The method for manufacturing the brazing material composition of claim 7, wherein a melting point range of the brazing material composition is between 600˜1200° C.

13. The method for manufacturing the brazing material composition of claim 11, wherein an average leakage rate of the brazing material composition is around 10⁻⁴ mbar·l/s/cm.
